(19) United States
(12) Patent Application Publication
(10) Pub. No.: US 2015/0248901 A1
(43) Pub. Date: Sep. 3, 2015

(54) DEVICES INCLUDING NEAR FIELD TRANSDUCERS

(71) Applicant: SEAGATE TECHNOLOGY LLC, Cupertino, CA (US)

(72) Inventors: Amit Vasant Itagi, Hugo, MN (US); Sethuraman Jayashankar, Excelsior, MN (US); Pierre Asselin, Richfield, MN (US); Werner Scholz, Edina, MN (US)

(21) Appl. No.: 14/525,286

(22) Filed: Oct. 28, 2014

Related U.S. Application Data
(60) Provisional application No. 61/945,884, filed on Feb. 28, 2014.

(51) Int. Cl. G11B 5/31

(52) U.S. Cl. CPC G11B 5/314; G11B 2005/0021

(57) ABSTRACT

An apparatus that includes a near field transducer (NFT), the NFT including, amongst other elements and materials: tantalum (Ta), niobium (Nb), molybdenum (Mo), rhodium (Rh), ruthenium (Ru), osmium (Os), titanium (Ti), zirconium (Zr), yttrium (Y), hafnium (Hf), platinum (Pt), palladium (Pd), vanadium (V), chromium (Cr), iridium (Ir), scandium (Sc), niobium (Ni), cobalt (Co), rhenium (Re), silicon (Si), geranium (Ge), alloys thereof, dispersions containing these elements, intermetallics based on these elements, admixtures thereof, or combinations thereof.

### PRIORITY

This application claims priority to U.S. Provisional Application No. 61/945,884 entitled “DEVICES INCLUDING NEAR FIELD TRANSDUCERS” filed on Feb. 28, 2014, the disclosure of which is incorporated herein by reference thereto.

### BACKGROUND

In heat assisted magnetic recording (HAMR), information bits are recorded on data storage media at elevated temperatures. The data bit dimension can be determined by the dimensions of the heated area in the storage medium or the dimensions of an area of the storage medium that is subjected to a magnetic field. In one approach, a beam of light is condensed to a small optical spot on the storage medium to heat a portion of the medium and reduce the magnetic coercivity of the heated portion. Data is then written to the reduced coercivity region.

Typically, the beam of light is focused or condensed to a small optical spot using a near field transducer (NFT). An exemplary type of a NFT is one that has a disc and a peg that focuses the light into the optical spot. Such NFTs are designed for use with visible light and are quite sensitive to variations in manufacturing. They also are typically made of noble metals, such as gold and as such are susceptible to metal reflow. Therefore, there remains a need for NFTs of different materials.

### SUMMARY

Disclosed is an apparatus that includes a near field transducer (NFT), the NFT including, amongst other elements and materials: tantalum (Ta), niobium (Nb), molybdenum (Mo), rhodium (Rh), ruthenium (Ru), osmium (Os), titanium (Ti), zirconium (Zr), yttrium (Y), hafnium (Hf), platinum (Pt), palladium (Pd), vanadium (V), chromium (Cr), iridium (Ir), scandium (Sc), niobium (Ni), cobalt (Co), rhenium (Re), silicon (Si), geranium (Ge), alloys thereof, dispersions containing these elements, intermetallics based on these elements, admixtures thereof, or combinations thereof.

Also disclosed is an apparatus that includes a light source configured to transmit energy at a wavelength of at least about 1300 nm; a waveguide; and a near field transducer (NFT), the NFT including tantalum (Ta), niobium (Nb), molybdenum (Mo), tungsten (W), palladium (Pd), osmium (Os), rhodium (Rh), alloys thereof, dispersions containing these elements, intermetallics based on these elements, admixtures thereof, or combinations thereof, wherein the light source, waveguide and NFT are configured to transmit light from the light source to the waveguide and finally to the NFT.

Also disclosed are methods that include providing energy from an energy source, the energy having a wavelength of at least about 1300 nm; transmitting the energy from the energy source to the receiving portion of a near field transducer (NFT), wherein the NFT includes tantalum (Ta), niobium (Nb), molybdenum (Mo), rhodium (Rh), ruthenium (Ru), osmium (Os), titanium (Ti), zirconium (Zr), yttrium (Y), hafnium (Hf), platinum (Pt), palladium (Pd), vanadium (V), chromium (Cr), iridium (Ir), scandium (Sc), niobium (Ni), cobalt (Co), rhenium (Re), silicon (Si), geranium (Ge), boron (B), carbon (C), alloys thereof, dispersions containing these elements, intermetallics based on these elements, admixtures thereof, or combinations thereof; and focusing the energy in the NFT to form an optical spot on an associated magnetic recording media.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE FIGURES

FIG. 1 is a pictorial representation of a data storage device in the form of a disc drive that can include a recording head constructed in accordance with an aspect of this disclosure.

FIG. 2 is a side elevation view of a recording head constructed in accordance with an aspect of the invention.

FIG. 3 is a schematic representation of a near field transducer.

FIG. 4 is a schematic representation of another near field transducer.

FIGS. 5A, 5B, and 5C show modeled maps of the electric field in the vicinity of the near field transducer for a gold NFT at 1550 nm (FIG. 5A), a tantalum NFT at 1550 nm (FIG. 5B), and a tantalum bent NFT at 1550 nm (FIG. 5C).

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

It is thought, but not relied upon that because of the materials utilized in the NFTs of disclosed devices, they can be utilized at wavelengths other than visible light. As such geometrical constraints can be lessened, loss of light by the NFT material can be lessened which can allow for larger NFTs, and reflow of the NFT material can be limited or even eliminated.

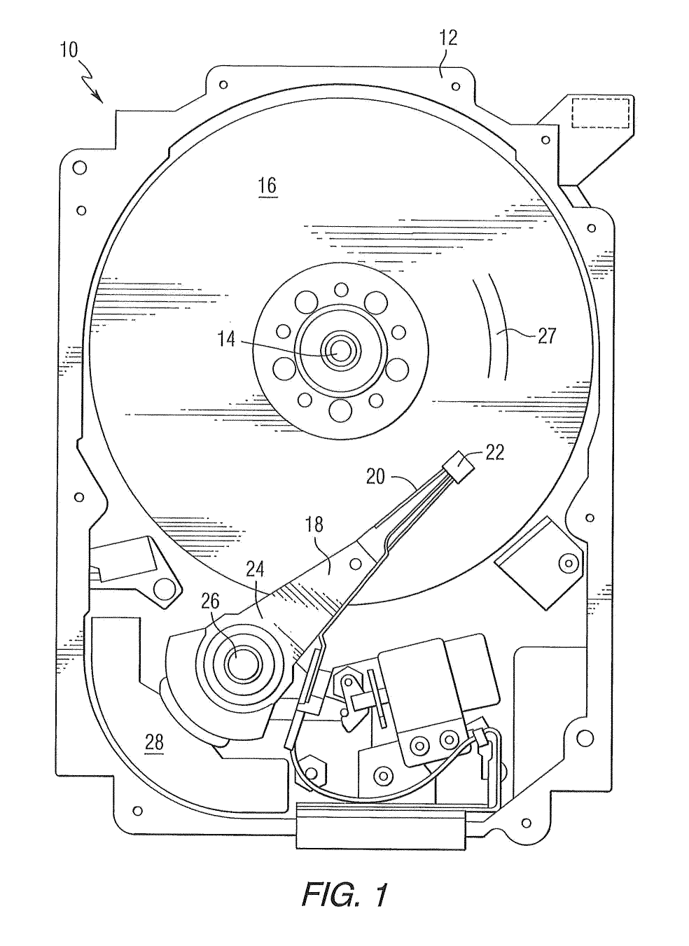

Disclosed herein are NFTs and devices that include such NFTs. FIG. 1 is a pictorial representation of a data storage device in the form of a disc drive 10 that can utilize disclosed NFTs. The disc drive 10 includes a housing 12 (with the upper portion removed and the lower portion visible in this view) sized and configured to contain the various components of the disc drive. The disc drive 10 includes a spindle motor 14 for rotating at least one magnetic storage media 16 within the housing. At least one arm 18 is contained within the housing 12, with each arm 18 having a first end 20 with a recording head or slider 22, and a second end 24 pivotally mounted on a shaft by a bearing 26. An actuator motor 28 is located at the arm's second end 24 for pivoting the arm 18 to position the recording head 22 over a desired sector or track 27 of the disc 16. The actuator motor 28 is regulated by a controller, which is not shown in this view and is well-known in the art. The storage media may include, for example, continuous media or bit patterned media.

For heat assisted magnetic recording (HAMR), electromagnetic radiation, for example, visible, infrared or ultraviolet light is directed onto a surface of the data storage media to raise the temperature of a localized area of the media to facilitate switching of the magnetization of the area. Recent designs of HAMR recording heads include a thin film waveguide on a slider to guide light toward the storage media and a near field transducer to focus the light to a spot size smaller than the diffraction limit. While FIG. 1 shows a disc drive, disclosed NFTs can be utilized in other devices that include a near field transducer.

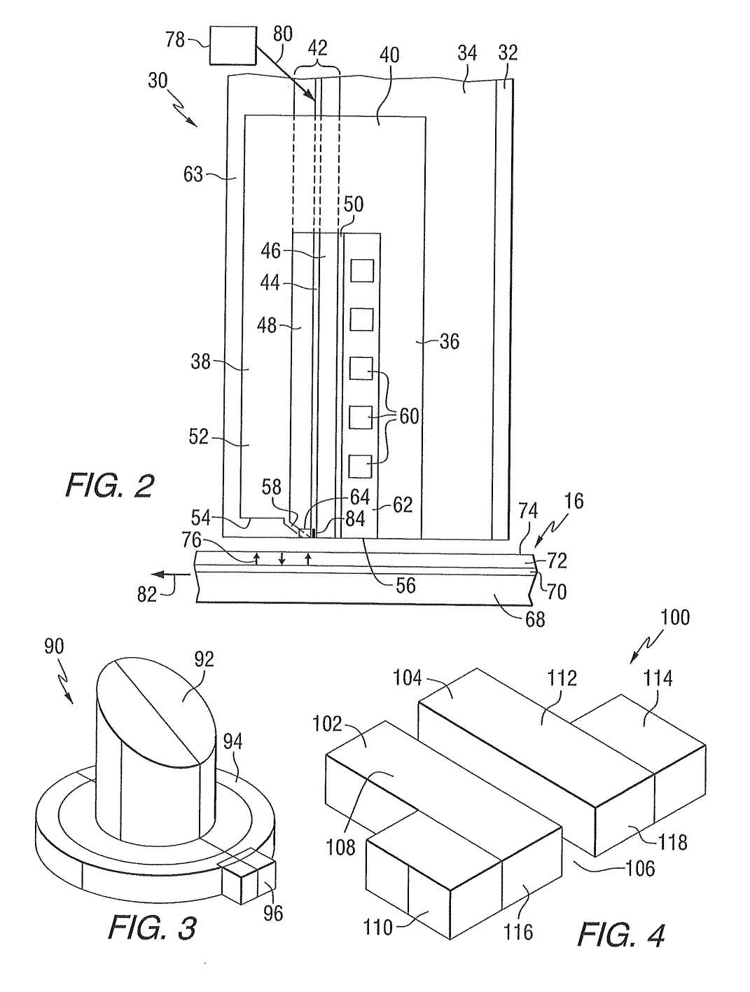

FIG. 2 is a side elevation view of a recording head that may include a disclosed NFT; the recording head is positioned near a storage media. The recording head 30 includes a substrate 32, a base coat 34 on the substrate, a bottom pole 36 on the base coat, and a top pole 38 that is magnetically coupled to the bottom pole through a yoke or pedestal 40. A waveguide 42 is positioned between the top and bottom poles. The waveguide includes a core layer 44 and cladding layers 46 and 48 on opposite sides of the core layer. A mirror 50 is positioned adjacent to one of the cladding layers. The top pole is a two-piece pole that includes a first portion, or pole body 52, having a first end 54 that is spaced from the air bearing surface 56, and a second portion, or sloped pole piece 58, extending from the first portion and tilted in a direction toward the bottom pole. The second portion is structured to include an end adjacent to the air bearing surface 56 of the recording head, with the end being closer to the waveguide than the first portion of the top pole. A planar coil 60 also extends between the top and bottom poles and around the pedestal. In this example, the top pole serves as a write pole and the bottom pole serves as a return pole.

An insulating material 62 separates the coil turns. In one example, the substrate can be AlTiC, the core layer can be Ta₂O₅, and the cladding layers (and other insulating layers) can be Al₂O₃. A top layer of insulating material 63 can be formed on the top pole. A heat sink 64 is positioned adjacent to the sloped pole piece 58. The heat sink can be comprised of a non-magnetic material, such as for example Au.

As illustrated in FIG. 2, the recording head 30 includes a structure for heating the magnetic storage media 16 proximate to where the write pole 58 applies the magnetic write field H to the storage media 16. In this example, the media 16 includes a substrate 68, a heat sink layer 70, a magnetic recording layer 72, and a protective layer 74. However, other types of media, such as bit patterned media can be used. A magnetic field H produced by current in the coil 60 is used to control the direction of magnetization of bits 76 in the recording layer of the media.

The storage media 16 is positioned adjacent to or under the recording head 30. The waveguide 42 conducts light from a source 78 of electromagnetic radiation, which may be, for example, ultraviolet, infrared, or visible light. The source may be, for example, a laser diode, or other suitable laser light source for directing a light beam 80 toward the waveguide 42. Specific exemplary types of light sources 78 can include, for example laser diodes, light emitting diodes (LEDs), edge emitting laser diodes (EELs), vertical cavity surface emitting lasers (VCSELs), and surface emitting diodes. In some embodiments, the light source can produce energy of a desired wavelength. Various techniques that are known for coupling the light beam 80 into the waveguide 42 may be used. Once the light beam 80 is coupled into the waveguide 42, the light propagates through the waveguide 42 toward a truncated end of the waveguide 42 that is formed adjacent the air bearing surface (ABS) of the recording head 30. Light exits the end of the waveguide and heats a portion of the media, as the media moves relative to the recording head as shown by arrow 82. A near-field transducer (NFT) 84 is positioned in or adjacent to the waveguide and at or near the air bearing surface. The heat sink material may be chosen such that it does not interfere with the resonance of the NFT.

Although the example of FIG. 2 shows a perpendicular magnetic recording head and a perpendicular magnetic storage media, it will be appreciated that the disclosure may also be used in conjunction with other types of recording heads and/or storage media where it may be desirable to concentrate light to a small spot.

FIG. 3 is a schematic view of a lollypop NFT 90 in combination with a heat sink 92. The NFT includes a disk shaped portion 94 and a peg 96 extending from the disk shaped portion. The heat sink 92 can be positioned between the disk shaped portion and the sloped portion of the top pole in FIG. 2. When mounted in a recording head, the peg may be exposed at the ABS and thus can be subjected to mechanical wearing.

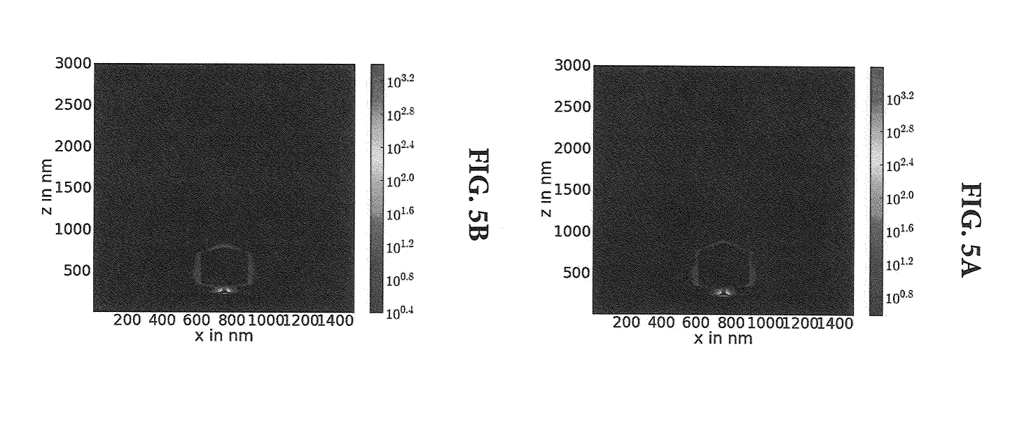

FIG. 4 is a schematic view of a coupled nanorod (CNR) NFT 100. This NFT includes two nanorods 102 and 104 separated by a gap 106. Nanorod 102 includes a first portion 108 and a second portion 110. Nanorod 104 includes a first portion 112 and a second portion 114. When mounted in a recording head, the ends 116 and 118 of the nanorods may be exposed at the ABS and thus be subject to mechanical wearing. FIGS. 3 and 4 show example NFTs. It should also be noted that NFTs disclosed in commonly assigned United States Patent Application entitled “ARTICLES INCLUDING A NEAR FIELD TRANSDUCER AND AT LEAST ONE WAVEGUIDE”, having attorney docket number 430.17084010, the disclosure of which is incorporated herein by reference thereto, can be utilized herein. It will be noted by one of skill in the art having read this specification, that the disclosure is not limited to any particular type of NFT. The materials described below may be used in various NFT configurations.

In some embodiments, disclosed NFTs may include refractory metals, such as tantalum (Ta), niobium (Nb), molybdenum (Mo), tungsten (W), and rhenium (Re) for example, as well as titanium (Ti), zirconium (Zr), hafnium (Hf), vanadium (Va), chromium (Cr), ruthenium (Ru), osmium (Os), iridium (Ir), and rhodium (Rh).

Melting points of refractory metals can generally be above 2000 K, can sometimes be above 2500 K, and can even sometimes be above 3000° K; while that of gold (Au), for example, is about 1000 K. A failure mode of NFTs is high temperature related ductile flow and creep strain. Flow and creep properties in metals and alloys is a thermal activated phenomenon. Flow and creep properties are exponentially dependent (Arrhenius dependence) on the homologous temperature, (Tₕ) where Tₕ=Temperature/T_{melting}. Thus, for the same operating temperature, higher melting materials have an exponentially better reliability than lower melting point materials. Diffusion activated phenomenon of NFT failure are also similarly dependent on the homologous temperature. Therefore, using a refractory metal may aid in preserving the dimensional stability of the NFT, for example the peg diameter and length (in a disc and peg type NFT) and the gap width (in a gap type NFT).

The use of such materials also allows for the use of longer wavelengths of input energy. Longer wavelengths can allow the use of larger NFTs thereby allowing for better heat sinking Longer wavelengths can also allow the transposition of the plasmonic field away from the light delivery system, which can allow the magnetic pole to not be sloped away from the light delivery system. Furthermore, at longer wavelengths, materials such as silicon (Si) for example, become transparent. This can further allow for the design of channel waveguides with low loss tight bends.

In some embodiments, energy within the short wavelength infrared (SWIR) range (1.4 to 3 micrometers or 1400 nm to 3000 nm) can be utilized. In some embodiments, energy having wavelengths that are at least 1400 nm can be utilized. In some embodiments, energy having wavelengths from 1400 to 1600 nm can be utilized. Wavelengths such as those listed above can be useful with NFTs made of various materials. For example, refractory metals exhibit plasmonic behavior at the noted wavelengths.

Use of materials such as refractory metals or transition metals for NFTs may result in slightly lowered coupling efficiency, but that disadvantage may be considered compensated for by the superior reliability thereof. Shifting the operating wavelengths to higher wavelengths, such as at least within the SWIR range also allows the use of high melting, environmentally stable and reliable plasmonic materials such as oxides (transparent conductive oxides for examples) and nitrides, which have lower losses compared to metals in the near- or mid-IR ranges. This may afford more options for materials (other than simply Al, Cu, Au and Ag for example) when higher wavelengths are utilized. The materials that can be used are also more rugged and reliable. It also becomes possible to engineer the band energy of the NFT via carrier concentration manipulation, doping, and alloying (within transition metals as well as with noble metals) for operation in the near- and mid-IR range. Furthermore, unlike monolithic Au, Ag, Al, or Cu, growth and deposition conditions of the new materials can be altered to tailor the plasmonic properties.

Possible materials for use in NFTs, as disclosed herein, can be compared by comparing the absolute value of the ratio of the real (n²-k², where n is the refractive index and k is the extinction coefficient) to the imaginary part (2nk) of the permittivity. This ratio (ε real/ε imaginary) is referred to herein as the figure of merit (“FOM”). In some embodiments, materials that can be utilized in NFTs can include those materials where n²-k² is very negative. In some embodiments, materials that can be utilized in NFTs can include materials where n²-k² is not greater than −50. In some embodiments, materials that can be utilized in NFTs can include materials where n²-k² is not greater than −60. In some embodiments, materials that can be utilized in NFTs can include those materials where the imaginary part, (2nk) is very small. In some embodiments, materials can be utilized in NFTs can include those materials where the imaginary part (2nk) is not greater than 30. In some embodiments, materials can be utilized in NFTs can include those materials where the imaginary part (2nk) is not greater than 25. Table 1 below presents data on various materials.

TABLE 1

| Material | Wavelength | n | k | n² − k² | 2nk | FOM |
|---|---|---|---|---|---|---|
| Tantalum | 1512 | 0.86 | 8.27 | −67.65 | 14.2244 | 4.76 |
| | 1590 | 0.89 | 8.77 | −76.12 | 15.6106 | 4.88 |
| Gold | 1550 | 0.18 | 10.2 | −104-01 | 3.672 | 28.32 |
| | 1500 | 1.357 | 10.4 | −108.03 | 7.4256 | 14.55 |
| | 830 | 0.09 | 5.39 | −29.04 | 0.9702 | 29.94 |
| | 800 | 0.08 | 4.98 | −24.79 | 0.7968 | 31.12 |
| Copper | 750 | 0.12 | 4.62 | −21.33 | 1.1088 | 19.24 |
| | 1240 | 0.44 | 8.48 | −71.72 | 7.4624 | 9.61 |
| Silver | 850 | 0.1 | 5.85 | −34.21 | 1.17 | 29.24 |
| | 1550 | 0.469 | 9.32 | −86.64 | 8.74216 | 9.91 |
| Niobium | 1459 | 1.35 | 7.74 | −58.09 | 20.898 | 2.78 |
| Molybdenum | 1512 | 1.64 | 7.35 | −51.33 | 24.108 | 2.13 |
| | 1240 | 1.94 | 5.58 | −27.37 | 21.6504 | 1.26 |
| Tungsten | 1590 | 1.6 | 7.83 | −58.75 | 25.056 | 2.34 |
| | 2000 | 1.38 | 10.4 | −106.26 | 28.704 | 3.70 |
| | 1550 | 2.5 | 5.6 | −25.11 | 28 | 0.90 |
| Rhenium | 1550 | 3.55 | 6.32 | −27.34 | 44.872 | 0.61 |
| Ruthenium | 1550 | 2.73 | 6.71 | −37.57 | 36.6366 | 1.03 |
| Palladium | 1550 | 3.35 | 8.06 | −53.74 | 54.002 | 1.00 |
| | 1390 | 2.8 | 7.65 | −50.68 | 42.84 | 1.18 |
| | 1610 | 3.01 | 8.59 | −64.73 | 51.7118 | 1.25 |
| Nickel | 1550 | 3.38 | 6.82 | −35.09 | 46.1032 | 0.76 |
| Osmium | 1550 | 2 | 5.95 | −31.40 | 23.8 | 1.32 |
| Platinum | 1550 | 5.31 | 7.04 | −21.37 | 74.7648 | 0.29 |
| Rhodium | 1550 | 3.63 | 10.3 | −92.91 | 74.778 | 1.24 |
| Beryllium | 1550 | 2.74 | 5.66 | −24.53 | 31.0168 | 0.79 |
| Cobalt-hcp | 1592 | 3.61 | 7.26 | −39.68 | 52.4172 | 0.76 |
| Cobalt-fcc | 1600 | 6.2 | 9.46 | −51.05 | 117.304 | 0.44 |
| Cobalt | 1390 | 3.42 | 6.77 | −34.14 | 46.3068 | 0.74 |
| Chromium | 1512 | 4.24 | 4.81 | −5.16 | 40.7888 | 0.13 |
| Iron | 1429 | 3.53 | 5.54 | −18.23 | 39.1124 | 0.47 |
| | 1550 | 3.38 | 6.82 | −35.09 | 46.1032 | 0.76 |
| Aluminum | 1550 | 1.44 | 16 | −253.93 | 46.08 | 5.51 |
| Iridium | Unknown | 4.5 | 9 | −60.75 | 81 | 0.75 |
| Titanium | 1390 | 3.67 | 4.37 | −5.63 | 32.0758 | 0.18 |
| Vanadium | 1549 | 2.52 | 5.77 | −26.94 | 29.0808 | 0.93 |
| GZO (Ga | 1500 | | | −0.10 | 0.9 | 0.11 |
| doped ZnO | | | | | | |
| TaN | 1500 | | | 10.00 | 30 | 0.33 |
| TiN | 1500 | | | −20.00 | 18 | 1.11 |
| TiN | 1500 | | | −20.00 | 20 | 1.00 |
| (Ar:N₂ = 2:8) | | | | | | |
| TiN | 1500 | | | −5.00 | 15 | 0.33 |
| (Ar:N₂ = 0:10) | | | | | | |
| TiN (300° C. | 1500 | | | −7.00 | 12 | 0.58 |
| Ar:N₂ = 4:6) | | | | | | |
| HfN | 1500 | | | −35.00 | 60 | 0.58 |
| ZrN | 1500 | | | −70.00 | 40 | 1.75 |
| ZrN-dielectric | 1500 | | | 10.00 | −18 | 0.56 |
| (N₂:Ar = 6:4) | | | | | | |
| ZrN-metallic | 1500 | | | −15.00 | 3 | 5.00 |
| (N₂:Ar = 2:8) | | | | | | |
| ITO | 1500 | | | 1.00 | 0.1 | 10.00 |
| (mp = 1800- | | | | | | |
| 2000 K) | | | | | | |

High temperature deformation processes (e)′ are a diffusional Arrhenius phenomenon, governed by the general equation: de/dt=(d/dt) const exp (−Q/RT), where de/dt is the reaction rate of the thermally activated process (which could lead to failure), Q is the activation energy for the process leading to potential failure, R is the universal gas constant, and T is the absolute temperature in Kelvin. Thus, high temperature flow deformation and thus device failure (creep) occurs faster at higher temperatures. Also, the lower melting the metal, the higher is the temperature driven creep deformation. For high temperature (creep) reliability, the concept of a homologous temperature is thus useful. The homologous temperature is the actual temperature divided by the melting point of the material, which both being expressed in Kelvin (K). In general, creep tends to occur at a significant rate when the homologous temperature is 0.4 or higher. Thus, the higher melting point a material has, the lower is its homologous temperature and lower is its temperature-driven dimensional stability. Table 2 below presents some physical properties of some of the materials disclosed above.

TABLE 2

| | | Boiling | | Young's | Vickers |
|---|---|---|---|---|---|
| | Melting Point | Point | Density | Modulus | Hardness |
| Material | (K) | (K) | (g/cm³) | (GPa) | (MPa) |
| Niobium | 2750 | 5017 | 8.57 | 105 | 1320 |
| Molybdenum | 2896 | 4912 | 10.28 | 329 | 1530 |
| Tantalum | 3290 | 5731 | 16.69 | 186 | 873 |
| Tungsten | 3695 | 5828 | 19.25 | 411 | 3430 |
| Rhenium | 3459 | 5869 | 21.02 | 463 | 2450 |

Disclosed herein are NFTs that can include, for example, tantalum (Ta), niobium (Nb), molybdenum (Mo), rhodium (Rh), ruthenium (Ru), osmium (Os), titanium (Ti), zirconium (Zr), yttrium (Y), hafnium (Hf), platinum (Pt), palladium (Pd), vanadium (V), chromium (Cr), iridium (Ir), scandium (Sc), niobium (Ni), cobalt (Co), rhenium (Re), silicon carbide (SiC), silicon (Si), geranium (Ge), boron (B), carbon (C), alloys thereof, dispersions containing these elements, intermetallics based on these elements, admixtures thereof, or combinations thereof. In some embodiments, disclosed NFTs can include Ta, Nb, Mo, W, Pd, Os, Rh, cobalt-fcc, Ir, V, TaN, or TiN, for example. In some embodiments, disclosed NFTs can include Ta, Nb, Mo, or W, for example.

Also disclosed herein are NFTs that can include, for example, conducting oxides such as doped or undoped oxides of zinc (Zn), tin (Sn), indium (In), and mixtures thereof, perovskites, alloys of Group III and Group V elements.

Also disclosed herein are NFTs that can include, for example, cadmium (Cd), barium (Ba), arsenic (As), polonium (Po), ytterbium (Yb), Promethium (Pm), protactinium (Pa), alloys thereof, dispersions containing these elements, intermetallics based on these elements, admixtures thereof, or combinations thereof.

Also disclosed herein are NFTs that can include, for example, tantalum (Ta), niobium (Nb), molybdenum (Mo), rhodium (Rh), ruthenium (Ru), osmium (Os), titanium (Ti), zirconium (Zr), yttrium (Y), hafnium (Hf), platinum (Pt), palladium (Pd), vanadium (V), chromium (Cr), iridium (Ir), scandium (Sc), niobium (Nb), cobalt (Co), rhenium (Re), silicon carbide (SiC), silicon (Si), geranium (Ge), boron (B), carbon (C), tungsten (W), iron (Fe), nickel (Ni), yttrium (Y), tin (Sn), antimony (Sb), bismuth (Bi), erbium (Er), gadolinium (Gd), indium (In), manganese (Mn), lanthanides and actinides and their alloys, dispersions containing these elements, intermetallics based on these elements such as but not limited to binary and ternary silicides, aluminides, germanides, nitrides, carbides of various stoichiometry of Niobium, Tantalum, Titanium, Palladium, Tungsten, Osmium, Rhodium, Cobalt, Iron, Aluminum, Molybdenum, Nickel, Vanadium, zirconium, Hafnium, Tin, Gadolinium, Erbium, Gallium, Indium, alloys of the above with group I elements such as Li, Na, K, etc., admixtures thereof, or combinations thereof.

Also disclosed herein are NFTs that can include gold (Au), silver (Ag), aluminum (Al), copper (Cu), or alloys thereof alloyed with or mixed with any element or material listed herein. Additionally, any alloys or material can also optionally include nitrogen (N), phosphorus (P), oxygen (O), sulfur (S), beryllium (Be), calcium (Ca), cerium (Ce), zinc (Zn), arsenic (As), selenium (Se), tellurium (Te), or mixtures thereof.

Disclosed alloys can include binary, ternary, or quaternary alloys. Binary and ternary alloys, for example, based on any element or elements listed herein, as well as with nitrogen (N), phosphorus (P), Group I elements, or combinations thereof can be utilized, for example. Alloying elements and constituents can be incorporated as constituents for solute strengthening, solute-based grain boundary pinning strengthening, dispersoid strengthening, interfacial strengthening, and diffusional rate modifications in the NFT material, for example.

Additionally, any type of dispersion, or any type of admixture can be utilized in disclosed NFTs. Additionally, intermetallics can be utilized. Illustrative types of intermetallics can include, for example, binary and ternary silicides, aluminides, germanides, nitrides, or carbides of various stoichiometries can be utilized. Additionally, perovskites, conductive oxides, and silicides, for example can be utilized on their own to form a NFT. Alternatively, conductive oxides, silicides, or perovskites can be utilized in composited or layered structures with plasmonic metals, alloys, or both, for example.

The present disclosure is illustrated by the following examples. It is to be understood that the particular examples, assumptions, modeling, and procedures are to be interpreted broadly in accordance with the scope and spirit of the invention as set forth herein.

### Examples

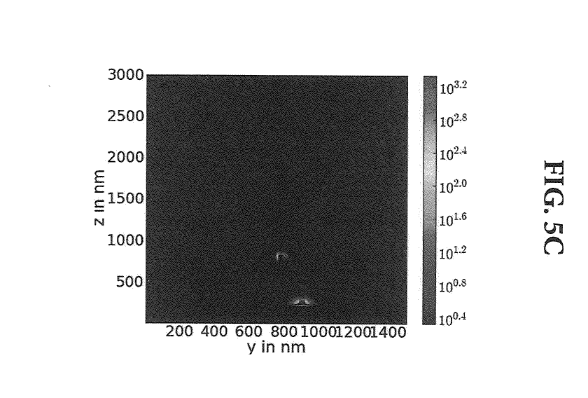

NFTs made of tantalum (Ta) and gold (Au) were modeled in order to compare their coupling efficiency (CE). FIGS. 5A, 5B, and 5C show maps of the electric field in the vicinity of the near field transducer for a gold NFT at 1550 nm (FIG. 5A), a tantalum NFT at 1550 nm (FIG. 5B), and a tantalum bent NFT at 1550 nm (FIG. 5C). The coupling efficiency (CE) of the gold NFT at 1550 nm was 4.0%, the CE of the tantalum NFT at 1550 nm was 2.8% and the CE of the bent tantalum NFT (having an optical field transposition in the downtrack direction by 100 nm) at 1550 nm was 2.5%. The intensity of the colors corresponds to the intensity of the electric field. The maps show high electric field intensity in the neighborhood of the peg at the bottom of the peg at the gap between the peg and the media. The model is based on a Finite Difference Time Domain model (FDTD).

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, “top” and “bottom” (or other terms like “upper” and “lower”) are utilized strictly for relative descriptions and do not imply any overall orientation of the article in which the described element is located.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise. The term “and/or” means one or all of the listed elements or a combination of any two or more of the listed elements.

As used herein, “have”, “having”, “include”, “including”, “comprise”, “comprising” or the like are used in their open ended sense, and generally mean “including, but not limited to”. It will be understood that “consisting essentially of”, “consisting of”, and the like are subsumed in “comprising” and the like. For example, a conductive trace that “comprises” silver may be a conductive trace that “consists of” silver or that “consists essentially of” silver.

As used herein, “consisting essentially of,” as it relates to a composition, apparatus, system, method or the like, means that the components of the composition, apparatus, system, method or the like are limited to the enumerated components and any other components that do not materially affect the basic and novel characteristic(s) of the composition, apparatus, system, method or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Also herein, the recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” a particular value, that value is included within the range.

Use of “first,” “second,” etc. in the description above and the claims that follow is not intended to necessarily indicate that the enumerated number of objects are present. For example, a “second” substrate is merely intended to differentiate from another infusion device (such as a “first” substrate). Use of “first,” “second,” etc. in the description above and the claims that follow is also not necessarily intended to indicate that one comes earlier in time than the other

Thus, embodiments of devices including near field transducers are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation.

1. An apparatus comprising:
a near field transducer (NFT), the NFT comprising osmium (Os), titanium (Ti), zirconium (Zr), yttrium (Y), hafnium (Hf), vanadium (V), scandium (Sc), rhenium (Re), geranium (Ge), or combinations thereof.

2. The apparatus according to claim 1, wherein the NFT comprises osmium (Os), or combinations thereof.

3. The apparatus according to claim 1, wherein the NFT comprises titanium (Ti), zirconium (Zr), or combinations thereof.

4. The apparatus according to claim 1, wherein the NFT comprise face centered cubic (fcc) cobalt.

5. The apparatus according to claim 1, wherein the material of the NFT has a melting point of about 2000 K or greater.

6. The apparatus according to claim 1, wherein the material of the NFT has a melting point of about 2500 K or greater.

7. The apparatus according to claim 1, wherein the material of the NFT has a melting point of about 3000 K or greater.

8. The apparatus according to claim 1 further comprising an energy source configured to transmit energy at a wavelength of at least about 1400 nm.

9. The apparatus according to claim 8, wherein the energy source transmits energy at a wavelength between about 1400 nm and about 1600 nm.

10. The apparatus according to claim 1, wherein the NFT is a peg and disc type NFT.

11. An apparatus comprising:
a light source configured to transmit energy at a wavelength of at least about 1300 nm;
a waveguide; and
a near field transducer (NFT), the NFT comprising osmium (Os), or combinations thereof,
wherein the light source, waveguide and NFT are configured to transmit light from the light source to the waveguide and finally to the NFT.

12. The apparatus according to claim 11, wherein the NFT comprises titanium (Ti), zirconium (Zr), or combinations thereof.

13. The apparatus according to claim 11, wherein the material of the NFT has a melting point of about 2000 K or greater.

14. The apparatus according to claim 11, wherein the material of the NFT has a melting point of about 2500 K or greater.

15. The apparatus according to claim 11, wherein the light source transmits energy at a wavelength of at least about 1400 nm.

16. A method comprising:
providing energy from an energy source, the energy having a wavelength of at least about 1300 nm;
transmitting the energy from the energy source to the receiving portion of a near field transducer (NFT), wherein the NFT comprises osmium (Os), titanium (Ti), zirconium (Zr), yttrium (Y), hafnium (Hf), vanadium (V), scandium (Sc), rhenium (Re), geranium (Ge), or combinations thereof; and
focusing the energy in the NFT to form an optical spot on an associated magnetic recording media.

17. The method according to claim 16, wherein the NFT comprises osmium (Os), or combinations thereof.

18. The method according to claim 16, wherein the NFT comprises face centered cubic (fcc) cobalt.

19. The method according to claim 16, wherein the energy has a wavelength from about 1400 nm to 1600 nm.

20. The method according to claim 16, wherein the energy source is a transverse electric (TE) mode laser.
